(19) United States
(12) Patent Application Publication
(10) Pub. No.: US 2023/0017122 A1
(43) Pub. Date: Jan. 19, 2023

(54) DOSING DEVICE AND METHOD FOR DISPENSING A FLOWABLE SUBSTANCE

(71) Applicant: CAPARTIS AG, Schaffhausen (CH)

(72) Inventor: Herbert WOHLGENANNT, Schaffhausen (CH)

(73) Assignee: CAPARTIS AG, Schaffhausen (CH)

(21) Appl. No.: 17/785,441

(22) PCT Filed: Dec. 18, 2020
(86) PCT No.: PCT/EP2020/087320

§ 371 Date: Jun. 15, 2022

(30) Foreign Application Priority Data
Dec. 18, 2019 (EP) 19217748.3

(51) Int. Cl. G01F 11/26; G01F 11/06

(52) U.S. Cl. CPC G01F 11/263; G01F 11/06

(57) ABSTRACT

The dosing device (1) for dispensing a flowable substance comprises a cap (2) with a pivot axis (S) and a closing part (4) arranged in the pivot axis (S), the closing part (4) dividing the pivot axis (S) into a flow chamber (2t) and a partial control chamber (2u), wherein upon pouring, the partial control chamber (2u) is filled with the flowable substance, and wherein the flowable substance is discharged via the flow chamber (2t) and a discharge opening (3b) until the closing part (4) is rotated to a position at which the discharge opening (3b) is closed by the closing part (4), preventing further discharge of the flowable substance.

This application is a National Stage completion of PCT/EP2020/087320 filed Dec. 18, 2020, which claims pri-ority from European Patent Application serial no. 19217748.3 filed Dec. 18, 2019.

### FIELD OF THE INVENTION

The invention relates to a dosing device and a method for dispensing a flowable substance.

### BACKGROUND OF THE INVENTION

A dosing device for dispensing a controlled amount of liquid is known, for example, from document wO2018/080966A1. This dosing device is used for dispensing a defined quantity of liquid from a container, the container having a spout to which the dosing device can be connected by being screwed on. This dosing device has the disadvantages that its manufacture is relatively complex and thus relatively expensive, and that the dosing is not satisfactorily reproducible under certain circumstances. In addition, the dose is delivered only when the container is compressed. Document US2331659 discloses another dosing device. This dosing device has, among other things, the disadvantages that the dispensed amount of liquid is fixed and cannot be changed, and that the dosing device has a valve cover which must be closed by hand after the amount of liquid has been dispensed, so that the hand or fingers are contaminated by any residues of the liquid when it is closed.

### SUMMARY OF THE INVENTION

Thus, it is the task of the invention to design a more advantageous dosing device for dispensing a controlled amount of a flowable substance, which in particular has improved dosing properties. In addition, it is the task of the invention to design a more advantageous method for dispensing a controlled amount of a flowable substance.

This task is solved with a dosing device having the features of the independent claim(s). The dependent claims concern further advantageous embodiments. The task is further solved with a method comprising the features of the independent claim(s). The dependent claims concern further advantageous method steps.

The task is solved in particular with a dosing device for dispensing a flowable substance, comprising a cap having a feed space which can be connected in a fluid-conducting manner to a container or a feed, and comprising a control chamber, a closing part and a discharge opening, the control chamber forming an inner space in which the closing part is arranged, the closing part being rotatably mounted about a pivot axis, the closing part dividing the interior space of the control chamber into a flow chamber and a partial control chamber, the flow chamber conductively connecting the flowable substance to the pouring orifice wherein the control chamber has an exchange opening via which the feed chamber is conductively connected to the partial control chamber, and wherein the control chamber has a control chamber inlet opening via which the feed chamber, depending on the position of the closing part, either with the flow chamber or with the partial control chamber the flowable substance is conductively connected, and wherein the closing part is rotatable up to a position in which the discharge opening is closed by the closing part, which prevents further leakage of the flowable substance from the discharge opening.

Preferably, the exchange opening, the control chamber inlet opening and the discharge opening are arranged successively in the direction of the longitudinal axis.

The task is further solved in particular with a method for dispensing a flowable substance from a container or a feed, wherein a dosing device comprising a cap and a control chamber is connected to the container or the feed, wherein a pivotable closing part is arranged in the control chamber, which divides the interior of the control chamber into a flow chamber and a partial control chamber, in that the supplied, the flowable substance supplied is fed to the flow chamber via a control chamber inlet opening during dispensing and is then fed to a discharge opening for dispensing, and in that part of the flowable substance, in particular a liquid, located in the container or the feed is fed to the partial control chamber, so that the volume of the partial control chamber filled with the flowable substance increases and the closing part is thereby pivoted until it bears against the discharge opening, and the dispensing of the flowable substance is thereby interrupted.

The dosing device according to the invention is suitable for dispensing a flowable substance, preferably a liquid or a gel being used as the flowable substance, wherein the flowable substance can also be a liquid containing solids, or also a free-flowing substance containing exclusively solids, in particular a free-flowing granular substance. The dosing device according to the invention is particularly suitable for dispensing a free-flowing substance in the household, for example for the metered dispensing of water, liquid detergent, fabric softener, dishwashing detergent, cleaning agent, beverages, oils, condensed milk, cream or body care products such as face cream.

The dosing device according to the invention is preferably placed on a spout of a container, for example by screwing or bouncing, whereby the container is preferably overturned for the dosed dispensing of the flowable substance, so that the flowable substance located in the container is dispensed via the dosing device in a dosed portion. For dispensing a further dosed portion, the container is preferably fully erected so that the dosing device can again assume a starting position and the pivotable closing part is again moved to a starting position, the container then being again overturned, after which a further dosed portion of the flowable substance is dispensed. The container is preferably designed as a plastic container, although this can also be designed as a rigid container or as an elastically deformable container. In an advantageous process step, the elastically deformable container is compressed shortly before dispensing the flowable substance or during dispensing of the flowable substance, so that the flowable substance in the container is pressurized, and the flowable substance is thereby dispensed more quickly, for example, or the flowable substance can be dispensed at different positions of the container. The container may also have a tubular configuration, wherein the dosing device is connected to the tubular container. The dosing device may also be connected to a feed, for example a hose, via which a flowable substance such as a liquid is supplied, the hose preferably being connected to a tank container. A metered dispensing of the flowable substance supplied via the feed is carried out similarly as with a tank, in that the dosing device connected to the feed is overturned or pressurized so that the supplied flowable substance is dispensed via the dosing device in a metered portion. Thereupon, the dosing device is preferably fully erected so that the dosing device, in particular the pivotable closing part, can again assume an initial position, the dosing device then being overturned again, after which a further metered portion of the flowable substance is dispensed.

The dosing device according to the invention has the advantage that, in the simplest embodiment, it consists of only three partial components, namely a cap, an adjusting or covering element and a closing part, which, when joined together, form the dosing device. These three subcomponents are preferably produced by injection molding, the injection molded parts produced in this way being designed as geometrically simple molded parts, so that both the production of the tools required for injection molding and the production of the injection molded parts can be carried out very inexpensively. The dosing device according to the invention has the further advantage that the three partial components can be assembled in a very simple manner and preferably automatically to form the dosing device according to the invention, so that this dosing device can be manufactured very inexpensively. In addition, a small amount of plastic is required for its manufacture, which results in the advantages that the required amount of plastic is inexpensive, and that a smaller amount of waste is produced after use of the dosing device. The extremely simple construction of the dosing device according to the invention makes it possible to use it repeatedly in the long term, since the dosing device can be easily disassembled, cleaned and reassembled, and its function is thus guaranteed in the long term. This multiple usability of the dosing device is considered an added value especially by environmentally conscious customers, since a container with a simple closure can be purchased and the closure can be replaced by the dosing device after opening the container.

The dosing device according to the invention also has the advantage that the metering is performed in a repeatably reliable manner. The arrangement disclosed in document WO2018/080966A1 comprises a linearly movable piston. Since the piston is freely movable in the cylinder, the disadvantage is that the movement of the piston can be hindered, for example, by the piston becoming jammed in the cylinder, by a liquid in the piston hindering the movement, or by residues such as dried liquid on the piston wall hindering or preventing movement. The dosing device according to the invention has the advantage that the movable closing part is mounted rotatably about an axis, and is preferably mounted in the cap, so that the closing part has a defined position with respect to the cap. Particularly advantageous is an embodiment in which the axle is part of the closing part and the bearing is part of the cap, so that the closing part is arranged exactly defined with respect to the cap and the control chamber located in the cap, so that the closing part has a defined position with respect to the boundary walls of the control chamber along the entire possible pivoting movement. Preferably, the axle is mounted in the cap in such a way that the axle has only a very small clearance, in particular in the direction of travel of the axle, in order on the one hand to avoid contact of the closing part with the lateral boundary walls of the control chamber, and on the other hand to ensure that the gap width between the closing part and the boundary walls remains small, and is for example in the range between 0.2 to 1 mm. The arrangement disclosed in document WO2018/080966A1 also has the disadvantage that a dose is delivered only when the container is compressed. The dosing device according to the invention can also deliver a dose without compressing a container. To make this possible, the dosing device according to the invention advantageously comprises a aeration tube which preferably allows an air exchange between the outer container space and the inner container space.

The arrangement disclosed in document WO 2018/080966A1 also has the disadvantage that the piston is in a dry state when dispensing for the first time, since it has never come into contact with the flowable substance to be dispensed before the first dispensing. The consequence of this is that the first dose dispensed by the dispensing device may be too small, since the piston in a dry state may be moved by the acting force of gravity when the container is tumbled, and this piston is therefore no longer in the intended starting position immediately after tumbling, with the result that the quantity of flowable substance dispensed in the process is too small. This disclosed arrangement thus exhibits reduced accuracy or reduced reproducibility of the dispensed metering quantity.

The device according to the invention is suitable for the metered dispensing of flowable substances, in particular for the metered dispensing of liquids such as water, liquid detergent, fabric softener, dishwashing detergent, cleaning agents, beverages, oil, or condensed milk. However, the device according to the invention is also suitable for the metered delivery of solid flowable substances such as granulates. The device according to the invention is thus suitable, for example, for dispensing substances such as pesticides or fertilizers.

The term “dose” as used herein is defined as the measured amount of flowable substance, hereinafter referred to as liquid, dispensed by the dosing device. The dose begins when the liquid first exits the dispensing orifice and ends when the flow of liquid exiting the dispensing orifice stops. The volume of liquid dosed in each case is typically 1 ml to 200 ml, preferably 3 ml to 50 ml, more preferably 10 ml to 30 ml, and even more preferably 15 ml to 30 ml.

The dosing device according to the invention is suitable for use in combination with rigid containers as well as with elastically compressible containers, “elastically compressible” being understood to mean a container that returns to its original shape without suffering permanent deformation as soon as the pressure is released. Advantageously, the dosing device according to the invention allows to dose a dose quantity which has a deviation of less than 10% with respect to a predetermined target dose, which can also be smaller or larger depending on the type of liquid.

The dosing device according to the invention is particularly suitable for domestic or household use, for example for cleaning agents such as hard surface cleaning agents, liquid detergent compositions or other cleaning agents such as fabric softeners and the like. Other applications include dosing devices for manual and machine dishwashing detergents or hair care products, or beverages such as syrups, spirits, alcohols, liquid coffee concentrates and the like, or food applications such as food pastes and liquid food ingredients.

Preferably, the metered liquid is a detergent composition. The metered liquid may be a Newtonian liquid or a shear dilution. By shear dilution is meant that said liquid is non-Newtonian and preferably has a viscosity that changes with changes in shear rate. The viscosity of the fluid may be from 1 to 350 mPa-s, preferably from 1 to 300 mPa-s, more preferably from 1 to 250 mPa s, even more preferably from 1 to 220 mPa s, even more preferably from 1 to 200 mPa s, and most preferably from 1 to 150 mPa s (measured at 20° C.)

Advantageously, the dosing device according to the invention comprises an adjusting element, preferably an adjusting element, with which the amount of flowable substance delivered by the dosing device can be adjusted as required. However, it may also prove advantageous to design the dosing device in such a way that it only dispenses a fixed predetermined quantity of flowable substance by dispensing with the adjustable setting element.

The invention is described below on the basis of several embodiments.

### BRIEF DESCRIPTION OF THE DRAWINGS

The drawings used to explain the embodiments show:

FIG. 1 a perspective view of a first embodiment of a dosing device from above;

FIG. 2 a perspective view of the dosing device from below;

FIG. 3 a frontal view of the dosing device from above;

FIG. 4 a perspective view of the dosing device from above, partially in longitudinal section;

FIG. 5 another perspective view of the dosing device from above, partially in longitudinal section;

FIG. 6 a perspective view of a cap of the dosing device from above;

FIG. 7 a longitudinal section through the cap according to FIG. 6 along section line A-A;

FIG. 8 a bottom view of the cap according to FIG. 6;

FIG. 9 a perspective view of the cap according to FIG. 6 from below;

FIG. 10 a perspective view of an adjusting element of the dosing device from above;

FIG. 11 a longitudinal section through the adjusting element according to FIG. 10 along the line of intersection B-B;

FIG. 12 a perspective view of the adjusting element according to FIG. 10 from below;

FIG. 13 a perspective view of a closing element from above;

FIG. 14 a perspective view of the closing part according to FIG. 13 from below;

FIG. 15 a view of a fully opened control chamber inlet opening of the cap;

FIG. 16 a view of only partially opened control chamber inlet opening of the cap;

FIG. 17 a longitudinal section through the dosing device along section line C-C according to FIG. 3 with the control chamber inlet opening fully open;

FIG. 18 a longitudinal section through the dosing device along section line C-C with the control chamber inlet opening closed;

FIG. 19 a longitudinal section through the dosing device along the line of intersection C-C at the beginning of the pouring of a liquid;

FIG. 20 a longitudinal section through the dosing device along the line of intersection C-C during pouring of the liquid;

FIG. 21 a longitudinal section through the dosing device along the line of intersection C-C after completion of pouring of the liquid;

FIG. 22 a perspective view of the underside of another embodiment of a cap;

FIG. 23 a longitudinal section through the cap according to FIG. 22 along section line D-D;

FIG. 24 a perspective view of a further embodiment of an adjusting element;

FIG. 25 a perspective view of the adjusting element according to FIG. 24 from below;

FIG. 26 a longitudinal section through the adjusting element according to FIG. 24;

FIG. 27 a longitudinal section through the cap according to FIG. 22 along the line of intersection E-E;

FIG. 28 a perspective view of a further embodiment of a dosing device;

FIG. 29 a longitudinal section through the dosing device according to FIG. 28.

In principle, identical parts are given the same reference signs in the drawings.

### DETAILED DESCRIPTION OF THE PREFERRED EMBODIMENTS

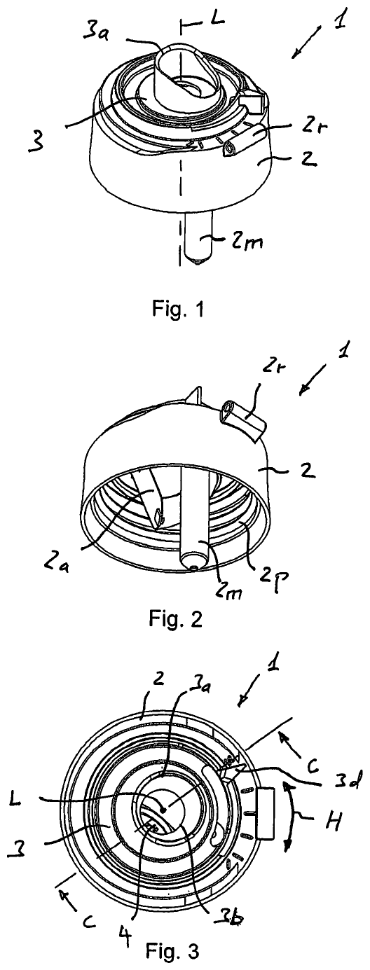

FIGS. 1 to 14 and 17 to 21 show, by means of a first embodiment, the same dosing device 1 and its parts from different perspectives, with different sections and in different states. FIGS. 1 to 3 show the assembled dosing device 1 from different views. The dosing device 1 comprises a cap 2 attachable to a container not shown comprising an internal thread 2p, a control chamber 2a and an optional aeration tube 2m, wherein the cap 2 or the dosing device 1 has a longitudinal axis L which is concentric with respect to the internal thread 2p. The dosing device 1 further comprises an adjusting element 3 having a discharge opening 3b and a spout 3a. The adjusting element 3 is rotatably mounted in the cap 2 and is rotatable back and forth in a direction of movement H with respect to the cap 2. Advantageously, the center of rotation of the adjusting element 3 coincides with the longitudinal axis L. However, in a further embodiment, the center of rotation of the adjusting element 3 could also be arranged eccentrically with respect to the longitudinal axis L. In an advantageous embodiment, the adjusting element 3 further comprises a pointer 3d so that the position of the mutual rotation of the adjusting element 3 and the cap 2 can be easily identified visually. Particularly preferably, a scale 2o is arranged on the cap 2, for example a number scale, along which the pointer 3d is movably arranged so that the pointer 3d can be moved to the same position in a reproducible manner, for example. As will be explained in detail below, the position of the pointer 3d is used to set the amount of dose delivered. In the top view according to FIG. 3, the closing part 4 located inside the control chamber 2a can also be seen.

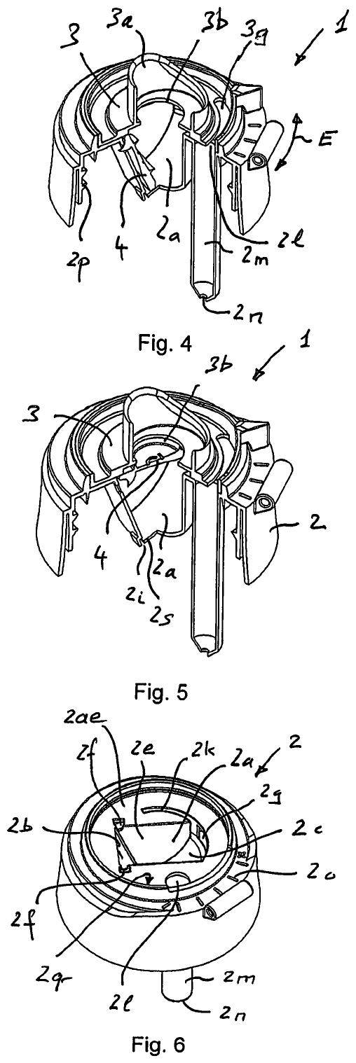

FIGS. 4 and 5 show a longitudinal section through the dosing device 1. FIG. 4 shows the cap 2 with the control chamber 2a, the internal thread 2p, and the aeration tube 2m with aeration inlet opening 2l and aeration outlet opening 2n. The adjusting element 3 comprises the spout 3a as well as the discharge opening 3b, and further comprises a aeration opening 3g extending in the circumferential direction H with respect to the longitudinal axis L, which is arranged with respect to the aeration inlet opening 2l in such a way that the aeration inlet opening 2l has a fluid-conducting connection to the ambient air at each rotational position of the adjusting element 3, thereby exchanging ambient air with the interior of the container via the aeration tube 2m and the aeration outlet opening 2n. The closure member 4 is pivotally mounted on the cap 2, and in FIG. 4 is in an initial position in which the pouring aperture 3b is fully open, and in FIG. 5 is in an end position in which the pouring aperture 3b is closed by the closure member 4 abutting thereon.

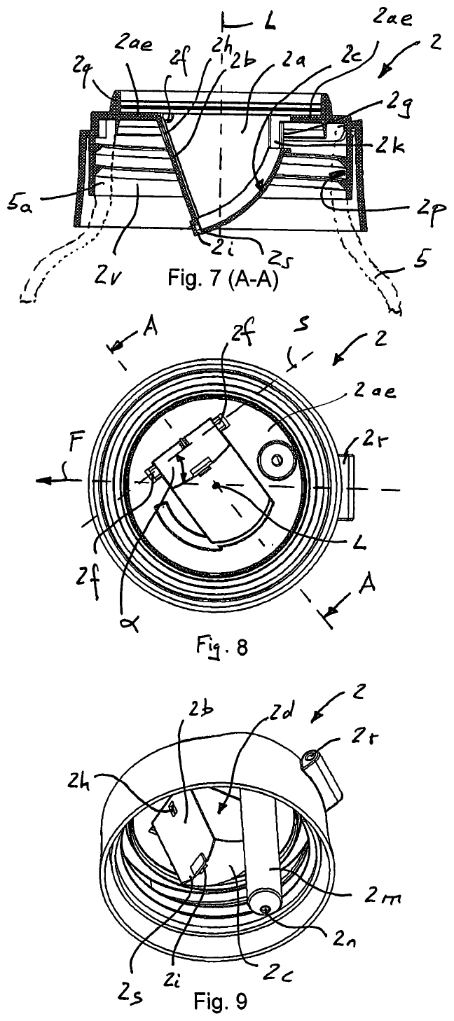

FIGS. 6 to 9 show the same cap 2 from different views. The cap 2 comprises an end wall 2ae, a control chamber 2a which is bounded within the cap 2 by a first boundary wall 2b, a second boundary wall 2c and a first and a second side wall 2d, 2e, whereas the control chamber 2a is open at the end of the cap 2. The cap 2 preferably further comprises two mutually spaced pivot bearings 2f, in which the bearing part of the closing part 4 is rotatably mounted. The pivot bearings 2f are preferably recessed in the end wall 2ae. The first boundary wall 2b is of planar design, whereas the second boundary wall 2c is concentric with respect to the axis S defined by the pivot bearings 2f. The first and second side walls 2d, 2e are mutually parallel. The control chamber 2a comprises a control chamber base 2s at which, when the cap 2 is upright, preferably at the lowermost point, a first exchange opening 2i is arranged which forms a fluid-conducting connection from the feed chamber 2v to the interior space of the control chamber 2a. Advantageously, the control chamber 2a further comprises a second exchange opening 2h arranged in the first boundary wall 2b, which also forms a fluid-conducting connection to the interior space of the control chamber 2a. Subsequently, the second boundary wall 2c has a control chamber inlet opening 2g at the end section opposite the control chamber base 2s. The cap 2 preferably comprises, at the end face thereof, a circularly extending first guide part 2q projecting beyond the end face, which is preferably arranged symmetrically with respect to the longitudinal axis L, and which guides the adjusting element 3 and surrounds it externally in the circumferential direction, so that the latter is rotatably mounted in the cap 2 about the longitudinal axis L. The first exchange opening (2i), the control chamber inlet opening (2g) and the discharge opening (3b) are arranged in succession in the direction of the longitudinal axis (L), as can be seen in particular from FIG. 7.

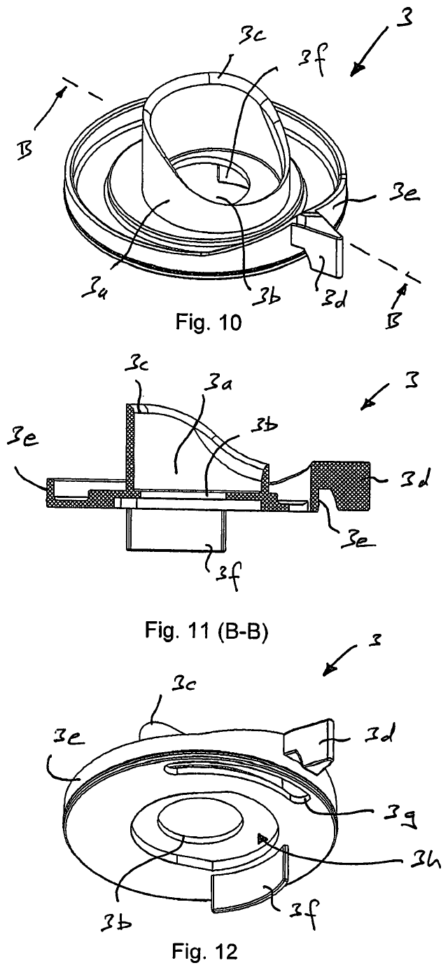

FIGS. 10 to 12 show the adjusting element 3 from different views. The adjusting element 3 comprises a circularly extending second guide part 3e, which is insertable into the first guide part 2q of the cap 2 so that the latter is held in the cap 2. The adjusting element 3 includes the discharge opening 3b, the spout 3a, a beak 3c, and the pointer 3d. The adjusting element 3 further comprises the aeration opening 3g, an adjusting element closure 3f, and a stop surface 3h. The adjusting element closure 3f is part of the adjusting element 3 so that, when the adjusting element 3 is inserted in the cap 2, it can also be rotated about the longitudinal axis L. FIG. 6 shows a side space 2k, wherein the adjusting element closure 3f is rotatably arranged in adjusting element 3 in such a way that it cannot cover the control inlet opening 2g at all, partially or completely, and can thus close it. The adjusting element 3 can be rotated about the longitudinal axis L so that the adjusting element closure 3f can be displaced into the side space 2k and come to lie at least partially or also completely in the side space 2k, so that the control inlet opening 2g is either only partially covered by the adjusting element closure 3f or is completely open. In FIG. 7, the opening of the side space 2k is shown in a frontal view, whereby the control chamber inlet opening 2g adjoining it is also visible. FIG. 7 also shows, in an indicative manner, a container 5 comprising a container nozzle 5a to which the cap 2 and thus the entire dosing device 1 is attached. The cap 2 comprises a feed chamber 2v through which the liquid present in the container 5 flows into the cap 2, the feed chamber 2v being separated by the control chamber 2a from the discharge opening 3b of the adjusting element 3, the control chamber 2a having passage openings, in particular the first exchange opening 2i and the control chamber inlet opening 2g, for supplying the liquid present in the container 5 in a controlled manner to the discharge opening 3b.

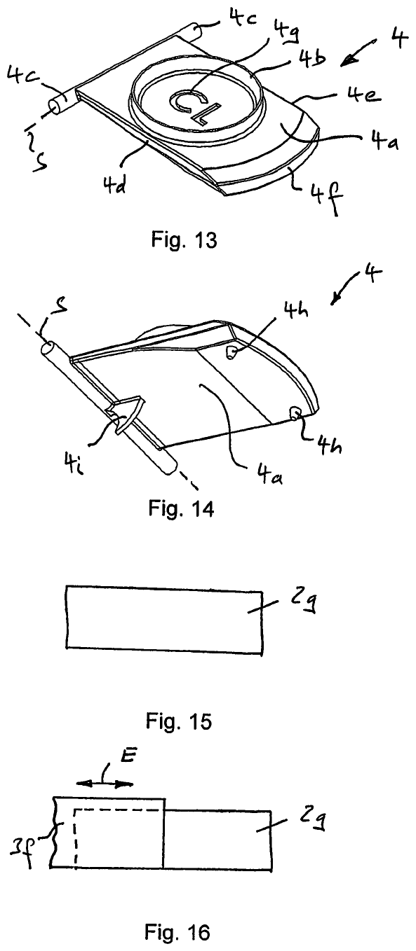

Preferably, the cap 2 comprises a hinged portion 2r to which a hinged cover cap, not shown, can be attached to cover or close the front face of the dosing device 1 after use thereof by the cover cap. Preferably, the spout 3a, as shown for example in FIG. 1, is arranged on a side facing away from the articulated part 2r, so that the container 5 is tipped or rotated during dosing and pouring in such a way that the spout 3a is lowered downwards and the articulated part 2r and the cover cap attached thereto, if any, are raised upwards, so that the cover cap does not obstruct the pouring. FIG. 8 shows with the pouring line F a preferred pouring direction or pivoting direction in which the dosing device 1 can be pivoted or tipped. As can be seen from FIG. 8, the two pivot bearings 2f define a pivot axis S about which the closing part 4 shown in FIGS. 13 and 14 is pivotably mounted. As shown in FIG. 8, the pivot axis S has an angle α with respect to the pouring line F. This angle is preferably in a range between 0° and 90°, preferably between 5° and 75°, and particularly preferably between 5° and 30°.

The described disadvantage of the prior art, that the dosing device is in a dry state when dosing for the first time, and that the dosing device therefore delivers too small a quantity of the flowable substance due to the acting force of gravity, can be avoided by a clever choice of the angle α described above, in that the angle α particularly preferably has a value in the range between 5° and 30°, depending, for example, on the viscosity of the liquid. By a corresponding choice of the angle α, the influence of gravity on the closing part 4 can be reduced and preferably at least approximately compensated, so that also the first delivered dose, in which the dosing device according to the invention is initially in a dry state, corresponds at least approximately to the subsequent dose quantities to be delivered. The torque force acting on the closing part 4 can be influenced by a corresponding selection of the angle α, the angle α preferably being selected in such a way that the closing part 4 does not pivot too quickly during initial dispensing, in which the closing part 4 is initially still in a dry state, and in particular does not pivot independently of the flowable substance flowing into the partial control chamber 2u.

The closing part 4 shown in FIGS. 13 and 14 comprises a pivot member 4a and a shaft 4c attached thereto, so that the pivot member 4a is rotatably supported in the pivot bearings 2f of the cap 2 via the shaft 4c about the pivot axis S. The closure part 4 further comprises a closure part 4b, a first longitudinal side 4d, a second longitudinal side 4e, a front side 4f, a support part 4h, an extension 4i and option-ally a label 4g. The closure part 4 is preferably formed in one piece, so that the shaft 4c is a part of the closure part 4.

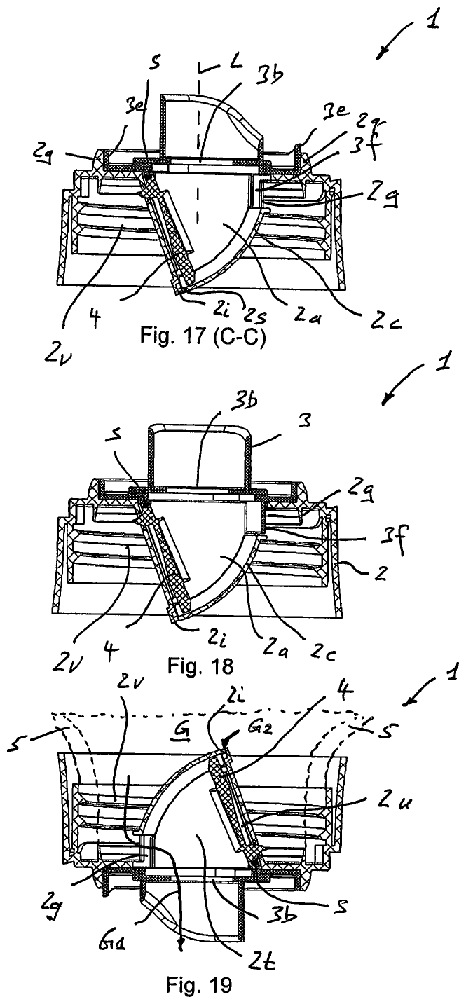

FIGS. 15 and 16 show a front view of the control chamber inlet opening 2g, whereby this forms a fully open passage opening in FIG. 15. In FIG. 16, by rotating the adjusting element 3 or by moving the adjusting element closure 3f, which is fixedly connected to the adjusting element, in the direction of movement H, the control chamber inlet opening 2g is partially covered, so that a smaller passage opening is formed through which a fluid or the flowable substance can flow. In an advantageous embodiment, the adjusting element 3 is rotatably mounted in the cap 2 so that the size of the passage opening can be adjusted depending on the desired dosing quantity. FIG. 17 shows in a longitudinal section of the dosing device 1 along the line of intersection C-C a fully opened passage opening, in which the control chamber inlet opening 2g, as shown in FIG. 15, is not covered by the adjusting element closure 3f, so that in FIG. 17 only the end face of the adjusting element closure 3f is visible, as well as the uncovered control chamber inlet opening 2g. FIG. 18 shows a further longitudinal section through the dosing device 1, in which the adjusting element 3 as well as its adjusting element closure 3f is twisted as shown in FIG. 16, so that, as shown in FIG. 18, the adjusting element closure 3f shown in section covers the control chamber inlet opening 2g at the location of the section.

The method for the metered dispensing of a free-flowing substance G, in particular a liquid, located in a container 5, with the aid of the dosing device 1 according to the invention is explained in detail below on the basis of FIGS. 17 to 21 with a liquid G located in the container 5, the container 5 connected to the metering device 1 being shown only indicated in FIG. 19, and not being shown in FIGS. 17, 18, 20 and 21. FIGS. 17 and 18 show the dosing device 1 in an upright position, with the container 5 connected to the dosing device 1, which is not shown, also in an upright position. In a first, optional step, the amount of flowable substance to be dispensed by the metering device 1 can be adjusted by rotating the adjusting element 3 to thereby adjust the area of the passage opening available for the flowable substance at the control chamber inlet opening 2g. Preferably, the optional first step is performed only once. In FIGS. 19 to 21, the adjusting element 3 remains in the basic position shown in FIG. 17. To dispense a dose of the flowable substance G, the container 5 with the dosing device 1 attached thereto is rotated or overturned about a horizontal axis so that the dosing device 1 is oriented downwards and is rotated through an angle of 180°, for example, as shown in FIGS. 19 to 21. If the container is not elastically deformable, or if no pressure is exerted on the elastically deformable container from the outside, then for pouring it is necessary to rotate the container 5 with metering device 1 attached to it, starting from the vertical arrangement shown in FIGS. 17 and 18, through an angular range between 90° and 270°, so that the dosing device 1 is aligned at least horizontally, and is preferably aligned running downwards. The position shown in FIGS. 19 to 21 is particularly advantageous when there is only a small residual amount of the flowable substance or liquid G in the container 5.

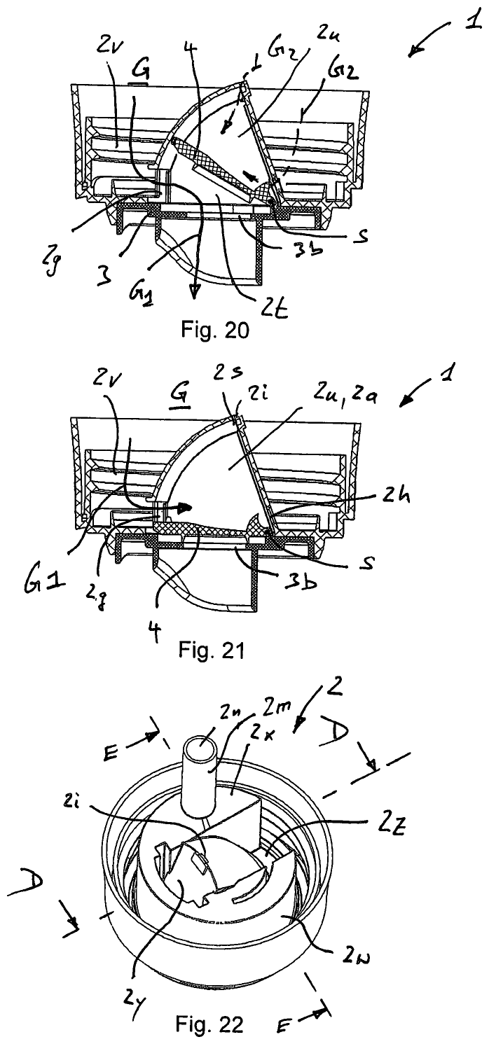

Dispensing of a metered quantity of the liquid G now takes place as shown in FIGS. 19 to 21. The closing part 4, which is arranged in the control chamber 2a and can be pivoted about the pivot axis S, divides the interior of the control chamber 2a into a flow chamber 2t and a partial control chamber 2u, the liquid G forming a first partial liquid flow G1 which is fed to the flow chamber 2t via the control chamber inlet opening 2g, the liquid G forming a second partial liquid flow G2 which is fed to the partial control chamber 2u at least via the first exchange opening 2i. The first partial liquid flow G1, after entering the flow chamber 2t, flows into the discharge opening 3b and is thereby discharged to the outside of the dosing device 1. The second partial liquid flow G2 flows, starting from the feed chamber 2v, via the first exchange opening 2i into the partial control chamber 2u and accumulates there, whereby the inflowing second partial liquid flow G2 has the effect that the quantity of liquid present in the partial control chamber 2u accumulates and thus continuously increases, and the closing part 4 is thereby increasingly pivoted in the direction of the outlet 3a, as shown in FIG. 20. The second partial liquid flow G2 flowing into the partial control chamber 2u visibly increases the volume of the partial control chamber 2u, so that the closing part 4 undergoes a pivoting movement until it rests against the stop surface 3h of the discharge opening 3b and the discharge opening 3b is thereby closed by the closing part 4, so that a further discharge of the first partial liquid flow G1 is prevented and the flow of the first partial liquid flow G1 is thus interrupted. The closing part 4 pivoting inside the control chamber 2a moves increasingly towards the discharge opening 3b during pouring, so that the discharge opening 3b is finally closed by the closing part 4 from the side of the control chamber 2a.

After the container 5 has been rotated or overturned, the discharge opening 3b is closed with a time delay by the closing part 4, so that the total amount of liquid dispensed by the dosing device 1 during a dosing process is influenced on the one hand by the time by which the discharge opening 3b is closed by the closing part 4, and on the other hand by the amount of liquid which flows out per unit of time via the control chamber inlet opening 2g and subsequently via the discharge opening 3b and is dispensed by the dosing device 1. As shown in FIGS. 15 and 16, the free area of the control chamber inlet opening 2g can be adjusted by moving the adjusting element closure 3f, and thus the amount of liquid dispensed during a dispensing operation. The time period by which the discharge opening 3b is closed by the closing member 4 depends on several factors, in particular on the size of the first exchange opening 2i and the viscosity of the liquid G. It may prove advantageous, as shown in FIGS. 19 to 21, to provide at least one further second exchange opening 2h in the control chamber 2a, through which an additional partial flow G2 of the liquid G can flow into the partial control chamber 2u, so that the second partial liquid flow G2 is composed of several partial flows, one partial flow per opening between liquid G and partial control chamber 2u.

After dispensing the liquid dose, the container with the dosing device 1 attached to it is erected again so that the dosing device 1 assumes, for example, the vertically upward position shown in FIG. 1. Immediately after erection, the closing part 4 is still in the position shown in FIG. 21. After erection of the dosing device 1, the liquid located in the partial control chamber 2u flows back into the feed chamber 2v via the first exchange opening 2i and/or the second exchange opening 2h, so that the partial control chamber 2u is progressively reduced in size and the flow chamber 2t is thereby enlarged, until all the liquid located in the partial control chamber 2u has flowed out, and the closing part 4 is again in the starting position shown in FIG. 17. After this, the dosing device 1 is ready to dispense another dosed quantity of liquid, in that the container 5 with the dosing device 1 attached to it is ready to be overturned again.

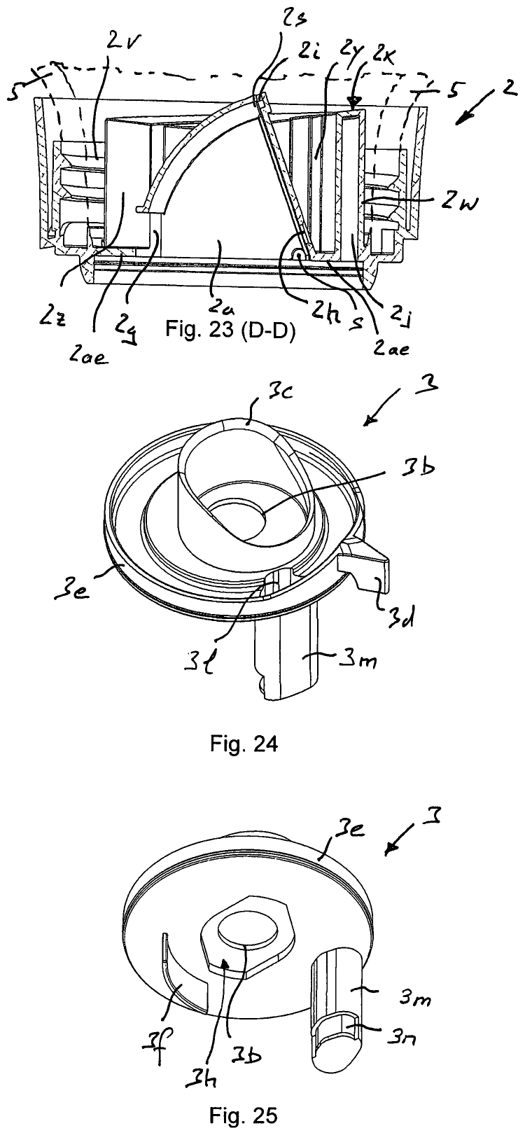

FIG. 22 shows a perspective view and FIG. 23 a longitudinal section along the line D-D of a further embodiment of a cap 2. In contrast to the cap 2 shown in FIGS. 6 to 10, the cap 2 shown in FIGS. 22 and 23 comprises a hollow body 2j, which in particular comprises a hollow body outer wall 2w and a hollow body end face 2x, which are arranged in such a way that a first collection area 2y and a second collection area 2z are formed in the cap 2. This hollow body 2j and the first and second collection areas 2y, 2z formed thereby, respectively, ensure that the function of the dosing device is still guaranteed even if there is a small residual amount of liquid in the container 5. In FIG. 23, the container 5 is shown indicated. The arrangement of the hollow body 2j has the consequence that the feed chamber 2v of the cap 2 is substantially reduced, respectively that the liquid present in the container accumulates substantially in the first and second collecting areas 2y, 2z, so that a dosing of the dispensed amount of liquid is possible even with a small residual amount of liquid, in that there is still sufficient liquid available which can flow into the flow chamber 2t of the control chamber 2a, which is not shown, via the first exchange opening 2i and/or the second exchange opening 2h, and which can flow out via the control chamber inlet opening 2g and the adjusting element 3 with discharge opening 3b, which is not shown.

The illustrated embodiments show the control chamber 2 in one possible embodiment. The control chamber 2 and the closing part 4 adapted with respect to the shape of the control chamber 2a may be configured in a plurality of shapes, such that the closing part 4 is rotatably supported in the cap 2 and divides the interior of the control chamber 2 into a flow chamber 2t and a partial control chamber 2u. For example, the first and second side walls 2d, 2e could be configured to extend in a bulbous manner in the direction of rotation of the pivot axis S, rather than being flat. The end face 4f could, for example, be angular, jagged, or sectionally star-shaped, with the second boundary wall 2c being configured in the opposite direction to the end face 4f, so that only a small gap is formed between the end face 4f and the boundary wall 2c.

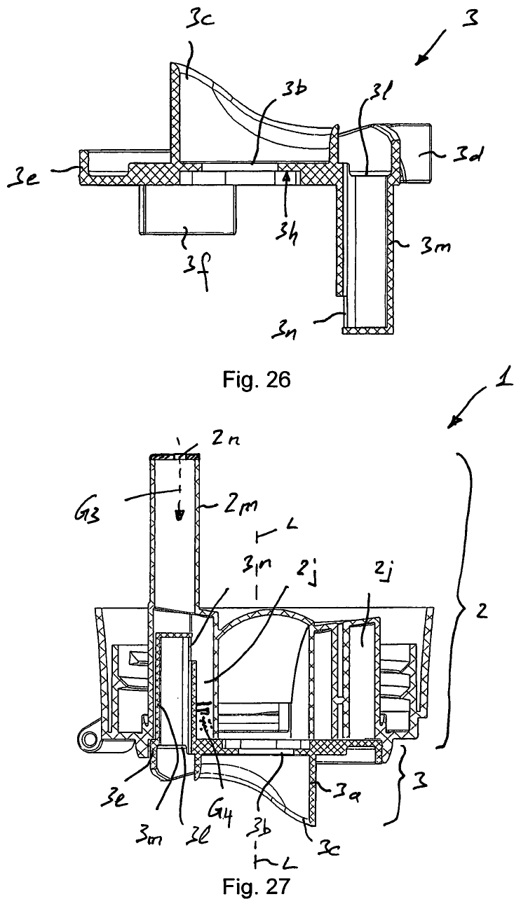

FIGS. 24 to 26 show a further embodiment of an adjusting element 3 which, in contrast to the adjusting element 3 shown in FIGS. 10 to 12, does not have an elongated aeration opening 3g extending in the circumferential direction, but instead has a aeration tube 3m with a second aeration inlet opening 3l and a second aeration outlet opening 3n. The adjusting element 3 according to FIGS. 24 to 26 is particularly advantageously suitable for combination with the cap 2 shown in FIGS. 22, 23 and 27. FIG. 27 shows an adjusting element 3 rotatably attached to the cap 2, wherein the adjusting element 3 does not have a pointer 3d, but is otherwise configured as shown in FIGS. 24 to 26. The adjusting element 3 can be rotated, for example, by twisting the spout 3a with the fingers. The spout 3a could also be more protruding in the direction of the longitudinal axis L, longer and for example tubular in shape, in order to form an even larger surface for actuation by the fingers. As shown in FIG. 27, the aeration tube 3m is arranged entirely within the cavity 2j, so that the latter extends within the cavity 2j in the longitudinal direction L. The adjusting element 3 is rotatably mounted in the first guide part 2q of the cap 2 about the longitudinal axis L via the second guide part 3e, whereby the aeration tube 3m can also be moved within the cavity 2j in the circumferential direction H. The arrangement shown in FIG. 27 has, in particular, the advantage that the flowable substance G₃ flowing back through the aeration outlet opening 2n and the aeration tube 2m during pouring, if any, is collected at the bottom of the cavity 2j as retained substance G₄, and is thus not discharged via the aeration tube 3m. As long as the level of the retained substance G₄ does not rise to the level of the second aeration outlet opening 3n, it can be prevented from flowing out via the aeration pipe 3m. Thus, it can be prevented that a flowable substance is uncontrollably discharged from the container 5 or from the feed chamber 2v by the dosing device 1 during dosing, which substantially increases the accuracy of the repeatedly equally large discharged amount of flowable substance. The amount of substance G₃ flowing back, if any, can be influenced via the size of the aeration outlet opening 2n and also via the time period during which the container is in the overturned position. These parameters are preferably selected in such a way that the level of substance G₄ does not rise to the second aeration outlet opening 3n during pouring. As soon as the container is pivoted back into the upright position, the retained substance G₄, if any, flows back via the aeration tube 2m and the aeration outlet opening 2n into the feed chamber 2v or into the interior of the container 5.

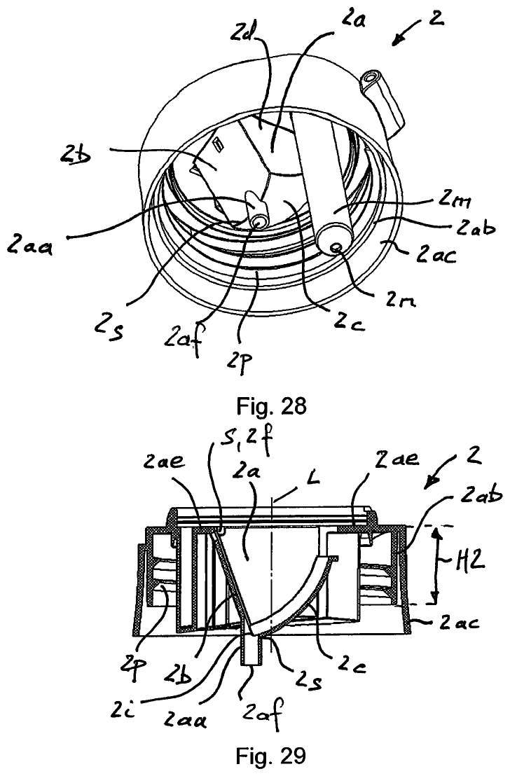

FIGS. 28 and 29 show another embodiment example of a cap 2 which is similar in design to the cap 2 shown in FIGS. 7 and 9, which is why essentially only the differences from the cap 2 shown in FIGS. 7 and 9 are explained below. On the control chamber base 2s of the control chamber 2a, in the region of the first exchange opening 2i, a guide channel 2aa having a connection opening 2af is arranged, wherein the guide channel 2aa conductively connects the first exchange opening 2i and the connection opening 2af to one another, that is, conductively connects them for a flowable substance, so that the flowable substance can flow back and forth via the guide channel 2aa between the feed chamber 2v and the interior space 2ad of the control chamber 2a. Advantageously, the guide channel 2aa, as shown in FIG. 29, runs parallel to the longitudinal axis L, and preferably in a straight line. However, the guide channel 2aa may also extend at an angle with respect to the longitudinal axis L, and/or may have a curved course. The cap 2 comprises a threaded cap 2ab with an internal thread 2p, which can be screwed onto a container. The threaded cap 2ab has a height H2 in the direction of the longitudinal axis L. Preferably, the length of the guide channel 2aa is at least 1/10 of the height H2, the length being in particular in a range from ⅓ to ⅔ of the height H2. The guide channel 2aa is preferably tubular, particularly preferably, as shown in FIGS. 28 and 29, as a round tube. However, the guide channel 2aa could also have other cross-sections, for example square, rectangular or oval. The inner diameter of the guide channel 2aa is preferably between 1 mm and 5 mm. Within the guide channel 2aa, the flowable substance exhibits an advantageous flow behavior, preferably a substantially laminar flow. The guide channel 2aa has the advantage that the exchange of the flowable substance between the feed chamber 2v and the control chamber 2a is reproducible. The guide channel 2aa thus has in particular the advantage that the flowable substance is fed from the feed chamber 2v into the control chamber 2a in a fluidically reproducible manner, which results in the advantage that the partial control chamber 2u is filled in a reproducible manner, and thus the amount of flowable substance dispensed from the cap 2 during a pouring operation is preferably particularly precisely reproducible, so that successive pouring operations have the same or substantially the same amount of flowable substance. The guide channel 2aa is particularly advantageously designed as a round tube, particularly advantageously extending in the direction of the longitudinal axis L. The guide channel 2aa thus preferably increases the reproducibility of the respective poured discharge quantity of the flowable substance located in the container 5, for example a fluid, which is discharged during successive pouring processes. The embodiment shown in FIGS. 28 and 29 also has the advantage that the dispensed quantity of flowable substance poured during a pouring operation preferably reproducibly corresponds exactly to the intended dispensed quantity even if the longitudinal axis L of the cap 2 does not run parallel to the gravitational force or to the vertical during the pouring operation, but rather to the vertical of the cap 2. is not parallel to the gravitational force or the vertical, but is held obliquely and has an angle with respect to the gravitational force, for example an angle in the range between 0 and 45° between the gravitational force or the vertical and the longitudinal axis L.

In the embodiments shown, the cap 2 comprises in each case a threaded cap 2ab with internal thread 2p and an additional outer cap 2ac. The threaded cap 2ab and the outer cap 2ac could also be designed together and thus in one piece.

Provided that the container is elastically deformable, the aeration tube 2m and/or the aeration tube 3m could be dispensed with in the dosing device 1.

The dosing device 1 could also be designed in such a way that it only dispenses a fixed set dosing quantity of liquid. For this purpose, for example, the adjusting element 3 could be connected to the dosing device 1 in such a way that the adjusting element 3 is not rotatable, but is fixedly arranged with respect to the dosing device 1, so that the free passage area of the control chamber inlet opening 2g is fixedly predetermined by the adjusting element closure 3f, which is not rotatably arranged. The adjusting element 3 could, for example, be arranged in a non-rotatable manner in the cap 2 by means of a cam which is not shown and which cooperates with the cap 2. It may also prove advantageous to provide a plurality of adjusting elements 3, which differ at least in the arrangement of the adjusting element closures 3f, in order to form a free passage area of different size depending on the selected adjusting element 3, so that, depending on the respectively desired metering quantity, the corresponding adjusting element 3 is fixed to the cap 2.

In another possible embodiment, the limiting element 3f could be dispensed with for the setting element 3, in that the control chamber inlet opening 3g has a fixed predetermined free passage area, which is adapted in accordance with the intended dosing quantity to be specified. In this embodiment, the adjusting element 3 would only have the purpose of covering the front side of the cap 2 and forming the discharge opening 3b with discharge 3a and, if necessary, additionally forming the optional aeration opening 3g or the optional aeration tube 3m with aeration inlet opening 2l and bell aeration outlet opening 2n.

In an advantageous embodiment, the closure part 4, as shown in FIG. 14, comprises a preferably mandrel-shaped extension 4i which, depending on the position of the closure part 4, engages in the second exchange opening 2h. Depending on the liquid contained in the container 5, there is a risk of a bubble or a thin liquid skin forming at the second exchange opening 2h, which impedes the flow of the liquid through the second exchange opening 2h. The function of the extension 4i is to ensure that no such bubble forms, or, if such a bubble has formed, that it is destroyed by the extension 4i entering the second exchange opening 2h. The extension 4i can be designed in a variety of shapes, preferably pointed.

In the embodiments shown in the figures, the adjusting element 3 is shown as a rotary part which is rotated in the circumferential direction of a longitudinal axis. However, the adjusting element 3 could also be designed as a rotary part that is rotatably mounted about an axis that deviates from the longitudinal axis. In addition, the adjusting element 3 could also be configured to be linearly movable so that it is linearly movably supported in the cap 2, wherein this linearly movable adjusting element closure 3f can adjustably cover the control chamber inlet opening 2g, thereby determining the opening area of the control chamber inlet opening 2g available for pouring.

1. A dosing device for dispensing a flowable substance, comprising:
a cap having a longitudinal axis and comprising a feed chamber fluidly connectable to a reservoir or a feed,
a control chamber having a first exchange opening and a control chamber inlet opening
a closing part, and
and a discharge opening,
wherein the first exchange opening, the control chamber inlet opening and the discharge opening are arranged successively in the direction of the longitudinal axis,
wherein the control chamber forms an inner space within which the closing part is arranged, wherein the closing part is rotatably mounted about a pivot axis, wherein the closing part divides the inner space of the control chamber into a flow chamber and a partial control chamber, wherein the flow chamber is conductively connected to the discharge opening, wherein the feed chamber is conductively connected to the partial control chamber via the first exchange opening and wherein the feed chamber is conductively connected either to the flow chamber or to the partial control chamber via the control chamber inlet opening, depending on the position of the closing part, and wherein the closing part is rotatable up to a position in which the discharge opening is closed by the closing part, which prevents further leakage of the flowable substance.

2. The dosing device according to claim 1, wherein the closing part closes the discharge opening from the side of the control chamber.

3. The dosing device according to claim 2, wherein the pivot axis runs perpendicular to the longitudinal axis, and that the pivot axis is arranged between the control chamber and the discharge opening in the direction of the longitudinal axis.

4. The dosing device according to claim 1, wherein it comprises an adjusting element with a limiting element, wherein the limiting element determines a free cross-sectional area of the control chamber inlet opening.

5. The dosing device according to claim 1, wherein the control chamber comprises a control chamber base at which the first exchange opening is arranged, and that the control chamber comprises control chamber walls which, starting from the control chamber base, extend in the direction of the discharge opening, the control chamber inlet opening being arranged in at least one of the control chamber walls towards the discharge opening.

6. The dosing device according to claim 4, wherein the adjusting element is rotatably mounted on the cap about the longitudinal axis.

7. The dosing device according to claim 6, wherein the cap has, starting from the control chamber inlet opening, a side space extending concentrically to the longitudinal axis for receiving the limiting element.

8. The dosing device according to claim 1, wherein the dosing device has a preferred pouring direction, and in that the pouring direction and the pivot axis intersect at an angle (α) in the range of between 5° and 90°.

9. The dosing device according to claim 1, wherein the control chamber is a part of the cap, and that the cap is designed in one piece.

10. The dosing device according to claim 1, wherein a control chamber wall is designed as a flat control chamber wall extending in the direction of the pivot axis, against which the closing part rests when the flow chamber is empty or largely empty.

11. The dosing device according to claim 10, wherein the planar control chamber wall has a second exchange opening towards the pivot axis.

12. The dosing device according to claim 11, wherein the closing part has an extension arranged for engagement in the second exchange opening.

13. The dosing device according to claim 10, wherein the control chamber comprises the planar control chamber wall, two mutually spaced control chamber walls extending parallel to the longitudinal axis, and a curved side wall extending concentrically to the pivot axis, which define the interior space of the control chamber.

14. The dosing device according to claim 1, wherein the cap has a cavity, projecting into the feed space and fluid-tight with respect to the feed space, in order to reduce the volume of the feed chamber.

15. The dosing device according to claim 14, wherein said cap comprises a first aeration tube having an aeration inlet opening and an aeration outlet opening, said first aeration tube extending in the direction of said longitudinal axis, said aeration inlet opening opening into said cavity, wherein the adjusting element comprises a second aeration tube, with a second aeration inlet opening and a second aeration outlet opening, wherein the second aeration inlet opening opens at an outer surface of the cap, and wherein the second aeration outlet opening extends into the cavity.

16. The dosing device according to claim 1, wherein a guide channel comprising a connection opening is arranged at the control chamber base of the control chamber, the guide channel conductively connecting the first exchange opening and the connection opening.

17. The dosing device according to claim 16, wherein the conducting channel extends in the direction of the longitudinal axis.

18. The dosing device according to claim 16, wherein the conducting channel is tubular.

19. A method for dispensing a flowable substance from a container or a feed, wherein a dosing device comprising a cap and a control chamber is connected to the container or the feed, wherein a pivotable closing part is arranged in the control chamber, which divides the interior of the control chamber into a flow chamber and a partial control chamber
in that the supplied flowable substance is supplied to the flow chamber via a control chamber inlet opening during discharge and is subsequently supplied to a discharge opening for discharge,
by supplying a part of the flowable substance located in the container or the feed to the partial control chamber so that the volume of the partial control chamber filled with the flowable substance increases, thereby pivoting the closing part until it abuts against the discharge opening and thereby interrupting the discharge of the flowable substance.

20. The method according to claim 19, wherein an exposed cross-sectional area of the control chamber inlet opening is changed by means of a limiting element, and thereby the amount of flowable substance dispensed by the dosing device is determined.

21. The method according to claim 19, wherein that the volume per unit time flowing into the partial control chamber during dispensing of the flowable substance is determined by the size of the first exchange opening.

22. The method according to claim 19, wherein the time required during the dispensing of the flowable substance to pivot the closing part from an initial position to an end position is determined by the size of the first exchange opening.
